(19) United States
(12) Patent Application Publication
(10) Pub. No.: US 2025/0119515 A1
(43) Pub. Date: Apr. 10, 2025

(54) PROJECTOR

(71) Applicant: SEIKO EPSON CORPORATION, Tokyo (JP)

(72) Inventors: Wataru YASUMATSU, Azumino-shi (JP); Masashi KATO, Azumino-shi (JP)

(21) Appl. No.: 18/906,228

(22) Filed: Oct. 4, 2024

(30) Foreign Application Priority Data
Oct. 4, 2023 (JP) 2023-172703

(51) Int. Cl. H04N 9/31

(52) U.S. Cl. CPC H04N 9/3167; H04N 9/3105; H04N 9/3161; H04N 9/3164

(57) ABSTRACT

A projector according to an aspect of the present disclosure includes a light source that emits light containing first laser light that belongs to a first wavelength band, a first polarizer that is configured with a dielectric multilayer film and separates a first polarized component of the first laser light incident on the first polarizer, a first transmissive liquid crystal panel that modulates the first polarized component of the first laser light separated by the first polarizer, and a projection system that projects the light modulated by the first transmissive liquid crystal panel. The first polarizer separates the first polarized component of the first laser light to cause the first polarized component to enter the first transmissive liquid crystal panel.

The present application is based on, and claims priority from JP Application Serial Number 2023-172703, filed Oct. 4, 2023, the disclosure of which is hereby incorporated by reference herein in its entirety.

### BACKGROUND

### 1. Technical Field

The present disclosure relates to a projector.

### 2. Related Art

when a projector uses high-optical-density light such as laser light, it has been known to use a polarizer plate having a wire grid structure as a light-incident-side polarizer plate for a liquid crystal panel (see JP-A-2019-003209, for example).

JP-A-2019-003209 is an example of the related art.

A polarizer plate having a wire grid structure described above has a problem of a decrease in light use efficiency because optical loss occurs due, for example, to interface reflection at the surface of the polarizer plate when it transmits light polarized in a predetermined direction.

### SUMMARY

To solve the problem described above, a projector according to an aspect of the present disclosure includes a light source configured to output light containing first laser light that belongs to a first wavelength band; a first polarizer configured with dielectric multilayer film and configured to separate a first polarized component of the first laser light incident on the first polarizer; a first transmissive liquid crystal panel configured to modulate the first polarized component of the first laser light separated by the first polarizer; and a projection system configured to project the light modulated by the first transmissive liquid crystal panel, and the first polarizer separates the first polarized component of the first laser light to cause the first polarized component to enter the first transmissive liquid crystal panel.

### BRIEF DESCRIPTION OF THE DRAWINGS

FIG. 1 shows a schematic configuration of a projector according to a first embodiment.

FIG. 2 shows the configuration of an illuminator.

FIG. 3 depicts graphs showing the spectral characteristics of a first polarizer.

FIG. 4 shows a schematic configuration of a projector according to a second embodiment.

FIG. 5 shows a schematic configuration of a projector according to a third embodiment.

FIG. 6 depicts graphs showing the spectral characteristics of a second polarizer.

FIG. 7 shows a schematic configuration of a projector according to a fourth embodiment.

FIG. 8 depicts graphs showing the spectral characteristics of the second polarizer.

FIG. 9 shows a schematic configuration of a projector according to a fifth embodiment.

### DESCRIPTION OF EMBODIMENTS

Embodiments of the present disclosure will be described below.

A projector according to an embodiment of the present disclosure is an example of a projector using liquid crystal panels as light modulators.

In the following drawings, elements are drawn at different dimensional scales in some cases for clarity of the elements.

### First Embodiment

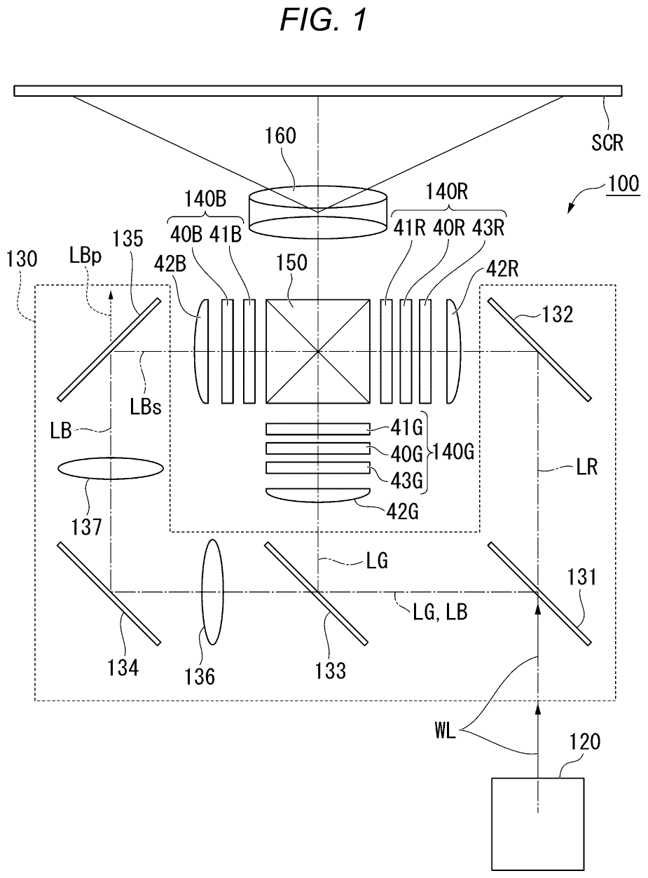

FIG. 1 shows a schematic configuration of a projector 100 according to the present embodiment.

The projector 100 according to the present embodiment is a projection-type image display apparatus that displays video images on a screen SCR, as shown in FIG. 1. The projector 100 includes an illuminator 120, a color separation system 130, light modulators 140R, 140G, and 140B, a light combining system 150, and a projection system 160. The projector 100 is a three-panel projector including three light modulators.

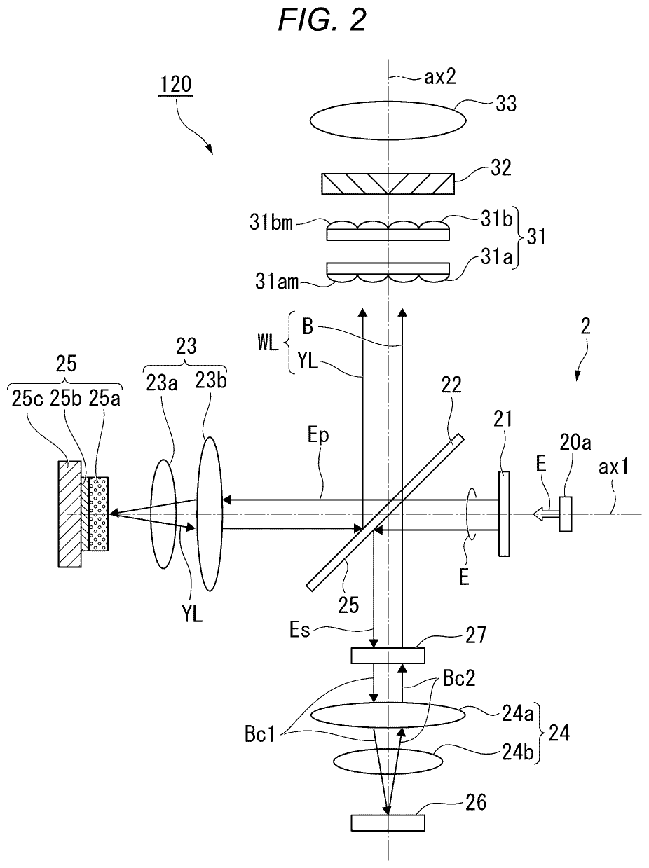

The illuminator 120 outputs illumination light WL toward the color separation system 130. The illumination light WL is illumination light in the projector 100, and contains red light LR, green light LG, and blue light LB. FIG. 2 shows the configuration of the illuminator 120.

The illuminator 120 includes a light source 2, an optical integration lens 31, a polarization converter 32, and a superimposing lens 33, as shown in FIG. 2.

The light source 2 includes a light emitter 20a, a first phase retarder 21, an optical element 22, a first light collection system 23, a second light collection system 24, a wavelength converter 25, a diffuser 26, and a second phase retarder 27.

The light emitter 20a, the first phase retarder 21, the optical element 22, the first light collection system 23, and the wavelength converter 25 are sequentially arranged in an optical axis ax1. The optical axis ax1 is the optical axis of the light emitter 20a.

The diffuser 26, the second light collection system 24, the second phase retarder 27, and the optical element 22, which constitute the light source 2, the optical integration lens 31, the polarization converter 32, and the superimposing lens 33, are sequentially arranged in an illumination optical axis ax2. The optical axis ax1 and the illumination optical axis ax2 are present in the same plane and perpendicular to each other.

The light emitter 20a is configured with a semiconductor laser. The light emitter 20a emits a blue beam E, which belongs to a blue wavelength band ranging, for example, from 445 nm to 460 nm. The light emitter 20a may be a semiconductor laser that emits a laser beam that belongs to a wavelength band other than that described above. The number of light emitters 20a may be one or more, and is not particularly limited to a specific number.

The first phase retarder 21 is disposed in the optical path of the blue beam E between the light emitter 20a and the optical element 22. The first phase retarder 21 is, for example, a rotatable half-wave plate. The blue beam E emitted from the light emitter 20a is linearly polarized light. Appropriately setting the angle of rotation of the first phase retarder 21 allows the blue beam E having passed through the first phase retarder 21 to be a beam containing an S-polarized component (first polarized component) and a P-polarized component (second polarized component) mixed with each other at a predetermined ratio, the two components polarized with respect to the optical element 22. Rotating the first phase retarder 21 can change the ratio between the S-polarized component to the P-polarized component. That is, the first phase retarder 21 separates the blue beam E from the light emitter 20a into the S-polarized component and the P-polarized component.

The blue beam E having passed through the first phase retarder 21 and therefore containing the S-polarized component and the P-polarized component is incident on the optical element 22.

The optical element 22 is disposed so as to incline by an angle of 45° with respect to the optical axis ax1 and the illumination optical axis ax2. The optical element 22 has a polarization separation function of separating the blue beam E into a beam Es containing the S-polarized component and a beam Ep containing the P-polarized component, the two components polarized with respect to the optical element 22. The optical element 22 is configured, for example, with a plate-shaped polarization separator.

The optical element 22 further has a color separation function of reflecting fluorescence YL, which belongs to a wavelength band different from that of the blue beam E, irrespective of the polarization state of the fluorescence YL.

The optical element 22 transmits the beam Ep, which is the P-polarized component separated from the blue beam E by the first phase retarder 21, and outputs the beam Ep toward the wavelength converter 25, and reflects the beam Es, which is the S-polarized component of the blue beam E, and outputs the beam Es toward the diffuser 26. The beam Ep, which is the P-polarized component and output from the optical element 22, enters the first light collection system 23. The first light collection system 23 collects the beam Ep as excitation light and directs the collected beam Ep toward a phosphor 25a of the wavelength converter 25. The first light collection system 23 is configured, for example, with a pair of lenses 23a and 23b.

The wavelength converter 25 includes a reflection layer 25b, the phosphor 25a provided at the light incident side of the reflection layer 25b, and a substrate 25c, which supports the phosphor 25a. That is, the wavelength converter 25 in the present embodiment is a fixed wavelength converter having a time-invariant region on which the beam Ep is incident.

The phosphor 25a converts the beam Ep, which is the excitation light, into the fluorescence YL having a wavelength band different from a first wavelength band. The phosphor 25a contains a ceramic phosphor configured with a polycrystalline phosphor that converts the beam Ep in terms of wavelength into the fluorescence YL. The wavelength band of the fluorescence YL is, for example, a yellow wavelength band ranging from 490 nm to 750 nm. That is, the fluorescence YL is yellow fluorescence containing a red light component and a green light component.

Specifically, the material of the phosphor 25a contains, for example, an yttrium-aluminum-garnet-based (YAG-based) phosphor. Consider YAG:Ce, which contains cerium (Ce) as an activator, by way of example, and the phosphor 25a is made, for example, of a material produced by mixing raw powder materials containing Y₂O₃, Al₂O₃, CeO₃, and other constituent elements with one another and causing the mixture to undergo a solid-phase reaction, Y—Al—O amorphous particles produced by using a coprecipitation method, a sol-gel method, or any other wet method, or YAG particles produced by using a spray-drying method, a flame-based thermal decomposition method, a thermal plasma method, or any other gas-phase method.

The reflection layer 25b reflects components of the fluorescence YL generated by the phosphor 25a that travel toward the substrate 25c. A heat dissipation member such as a heat sink may be disposed at the surface of the substrate 25c that is opposite from the surface that supports the phosphor 25a.

Out of the fluorescence YL generated by the phosphor 25a, part of the fluorescence YL is reflected off the reflection layer 25b and exits out of the phosphor 25a. Another part of the fluorescence YL generated by the phosphor 25a exits out of the phosphor 25a without traveling via the reflection layer 25b. The fluorescence YL is thus output from the wavelength converter 25.

The fluorescence YL emitted from the phosphor 25a is non-polarized light. The fluorescence YL passes through the first light collection system 23 and is then incident on the optical element 22. The fluorescence YL is reflected off the optical element 22 and travels toward the optical integration lens 31.

In contrast, the beam Es, which is the S-polarized component of the blue beam E output from the optical element 22, enters the second phase retarder 27. The second phase retarder 27 is configured with a quarter-wave plate disposed in the optical path between the optical element 22 and the diffuser 26. The S-polarized beam Es output from the optical element 22 is therefore converted by the second phase retarder 27, for example, into clockwise circularly polarized blue light Bc1, which then enters the second light collection system 24. The second light collection system 24 is configured, for example, with a pair of lenses 24a and 24b, and causes the blue light Bc1 to be incident on the diffuser 26 with the blue light Bc1 collected at the diffuser 26.

The diffuser 26 diffusely reflects the blue light Bc1 output from the second light collection system 24 toward the optical element 22. The diffuser 26 preferably reflects the blue light Bc1 in the Lambert reflection scheme but does not disturb the polarization state thereof. The diffuser 26 may have a configuration in which a disk-shaped diffusive reflector is rotated.

The light diffusively reflected off the diffuser 26 is hereinafter referred to as blue light Bc2. According to the present embodiment, diffusely reflecting the blue light Bc1 produces blue light Bc2 having a substantially uniform illuminance distribution. For example, the clockwise circularly polarized blue light Bc1 is reflected in the form of counterclockwise circularly polarized blue light Bc2. The blue light Bc2 is converted by the second light collection system 24 into parallelized light, which then enters the second phase retarder 27 again.

The counterclockwise circularly polarized blue light Bc2 is converted by the second phase retarder 27 into P-polarized blue light B. The P-polarized blue light B passes through the optical element 22 and exits toward the optical integration lens 31.

In the present embodiment, the optical element 22 outputs the blue light B incident from the diffuser 26 and the fluorescence YL incident from the wavelength converter 25 in the same direction. The blue light B and the fluorescence YL are therefore combined with each other by the optical element 22 into white illumination light WL.

The illumination light WL, which is the combined light from the optical element 22, enters the optical integration lens 31. The optical integration lens 31 includes a first multi-lens 31a and a second multi-lens 31b. The first multi-lens 31a includes multiple first lenslets 31am, which divide the illumination light WL into multiple sub-beam fluxes.

The surfaces of the first lenslets 31am, which form the lens surface of the first multi-lens 31a, and image formation regions of the light modulators 140R, 140G, and 140B are conjugate with each other. The shape of each of the first lenslets 31am is therefore substantially similar to the shape of the image formation region of each of the light modulators 140R, 140G, and 140B. The sub-luminous fluxes output from the first multi-lens 31a are each therefore efficiently incident on the image formation regions of the light modulators 140R, 140G, and 140B.

The second multi-lens 31b includes multiple second lenslets 31bm corresponding to the multiple first lenslets 31am of the first multi-lens 31a. The second multi-lens 31b, along with the superimposing lens 33, forms an image of each of the first lenslets 31am of the first multi-lens 31a in the vicinity of the image formation region of each of the light modulators 140R, 140G, and 140B.

The illumination light WL having passed through the optical integration lens 31 enters the polarization converter 32. The polarization converter 32 is configured with polarization separation films and phase retarders (half-wave plates) arranged in an array. The polarization converter 32 converts the illumination light WL into a predetermined polarized component.

More specifically, the polarization converter 32 converts the polarization directions of the red light LR and the green light LG separated from the illumination light WL as will be described later into the polarization direction that allows the red light LR and the green light LG to pass through the light-incident-side polarizer plates disposed at the light incident side of the light modulators 140R and 140G, which will be described later. The polarization converter 32 converts the polarization direction of the blue light LB separated from the illumination light WL into the first polarized component to be reflected off a first polarizer 135, which will be described later and is disposed upstream from the light modulator 140B.

Aligning the polarization directions of the illumination light WL with each other with the polarization converter 32 as described above allows reduction in optical loss caused when the illumination light WL is separated in terms of polarization, as will be described later, to further increase the light use efficiency.

The illumination light WL having passed through the polarization converter 32 enters the superimposing lens 33. The superimposing lens 33 in cooperation with the optical integration lens 31 homogenizes the illuminance distribution of the illumination light WL in an illumination receiving region.

Referring back to FIG. 1, the color separation system 130 separates the illumination light WL into the red light LR, the green light LG, and the blue light LB. The red light LR and the green light LG are separated from the yellow fluorescence YL contained in the illumination light WL. The blue light LB corresponds to the blue light B contained in the illumination light WL.

The color separation system 130 includes a first dichroic mirror 131, a first mirror 132, a second dichroic mirror 133, a second mirror 134, the first polarizer 135, a first relay lens 136, and a second relay lens 137.

The first dichroic mirror 131 is disposed in the optical path of the illumination light WL output from the illuminator 120, and separates the incident illumination light WL into the red light LR, and the mixture of the green light LG and the blue light LB. The first dichroic mirror 131 transmits the red light LR and reflects the green light LG and the blue light LB. The first mirror 132 is disposed in the optical path of the red light LR output from the first dichroic mirror 131, and reflects the red light LR toward the light modulator 140R.

The second dichroic mirror 133 is disposed in the optical path common to the green light LG and the blue light LB output from the first dichroic mirror 131, and separates the green light LG and the blue light LB from each other. The second dichroic mirror 133 transmits the blue light LB and reflects the green light LG. The green light LG enters the light modulator 140G from the second dichroic mirror 133.

The second mirror 134 is disposed in the optical path of the blue light LB output from the second dichroic mirror 133, and reflects the blue light LB toward the first polarizer 135. The first polarizer 135 reflects predetermined polarized component of the blue light LB and causes the reflected component to enter the light modulator 140B.

The blue light LB corresponds to the laser light that belongs to the blue wavelength band out of the illumination light WL and is the light output from the light source 2. That is, the blue light LB in the present embodiment corresponds to the “first laser light that belongs to a first wavelength band” in the claims.

The first polarizer 135 in the present embodiment is configured with a dielectric multilayer film, and separates the S-polarized component and the P-polarized component of the incident blue light LB from each other, the two components polarized with respect to a transmissive liquid crystal panel 40B of the light modulator 140B. The first polarizer 135 is disposed so as to incline by the angle of 45° with respect to the chief ray of the incident blue light LB. According to the configuration described above, the exiting direction of the S-polarized component separated by the first polarizer 135 is readily controlled, so that the separated light can be efficiently incident on the light modulator 140B.

In the following description, the polarization directions of the S-polarized light and the P-polarized light in the blue light LB indicate the polarization directions with respect to the transmissive liquid crystal panel 40B unless otherwise specified.

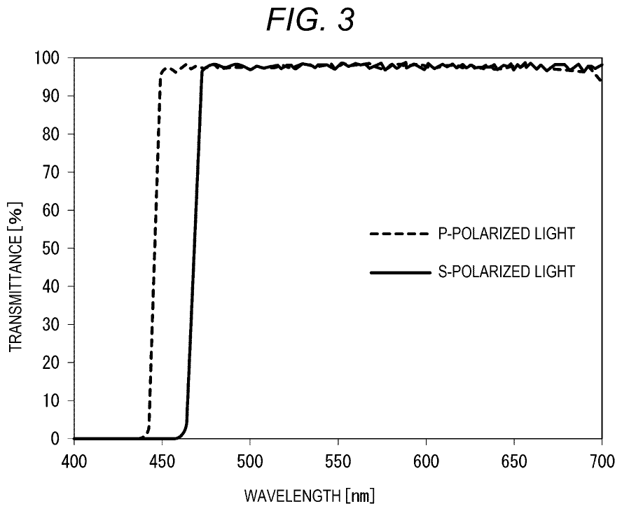

FIG. 3 depicts graphs showing the spectral characteristics of the first polarizer 135.

The first polarizer 135 has spectrally characterized to transmit the P-polarized blue light LB, which belongs to the blue wavelength band (first wavelength band) ranging from 445 nm to 460 nm and reflect the S-polarized blue light LB, as shown in FIG. 3.

The blue light LB, which is the laser light and is output from the illuminator 120, exits as the S-polarized light, but the blue light LB passes through multiple optical components before incident on the first polarizer 135, so that the polarization direction of the blue light LB is slightly disturbed. Therefore, the blue light LB is light primarily made of the S-polarized light, but slightly contains the P-polarized light.

The first polarizer 135 transmits blue light LBp, which is the P-polarized component, out of the incident blue light LB, and reflects blue light LBs, which is the S-polarized component, out of the blue light LB. Note that the amount of blue light LBp passing through the first polarizer 135 is very small and is blocked by a light blocking member that is not shown, so that the blue light LBp does not contribute to stray light.

Accordingly, the first polarizer 135 separates the blue light LBs, which is the S-polarized component, which is the first polarized component, from the blue light LB, and causes the blue light LBs to enter the light modulator 140B. That is, in the present embodiment, the blue light LBs corresponds to the “first polarized component of the first laser light” in the claims.

The first relay lens 136 is disposed in the optical path of the blue light LB between the second dichroic mirror 133 and the second mirror 134. The second relay lens 137 is disposed in the optical path of the blue light LB between the second mirror 134 and the first polarizer 135. Providing the first relay lens 136 and the second relay lens 137 compensates for optical loss of the blue light LB. The optical loss of the blue light LB is caused by the fact that the optical path length of the blue light LB from the first dichroic mirror 131 to the light modulator 140B is longer than the optical path length of the red light LR from the first dichroic mirror 131 to the light modulator 140R and the optical path length of the green light LG from the first dichroic mirror 131 to the light modulator 140G.

A field lens 42R is disposed in the optical path of the red light LR between the first mirror 132 and the light modulator 140R. The field lens 42R causes the red light LR to be efficiently incident on the light modulator 140R.

A field lens 42G is disposed in the optical path of the green light LG between the second dichroic mirror 133 and the light modulator 140G. The field lens 42G causes the green light LG to be efficiently incident on the light modulator 140G.

A field lens 42B is disposed in the optical path of the blue light LB between the first polarizer 135 and the light modulator 140B. The field lens 42B causes the blue light LB to be efficiently incident on the light modulator 140B.

The light modulator 140R is disposed in the optical path of the red light LR reflected off the first mirror 132 and output from the first mirror 132.

The light modulator 140R is configured with a transmissive liquid crystal panel 40R, a light-incident-side polarizer plate 43R, and a light-exiting-side polarizer plate 41R.

The transmissive liquid crystal panel 40R modulates the incident red light LR in accordance with image information input from an image input apparatus that is not shown to form and output red image light. The image input apparatus is, for example, a personal computer or a portable terminal device.

The light-incident-side polarizer plate 43R is provided at the light incident side of the transmissive liquid crystal panel 40R. The red light LR is light that belongs to a portion obtained by separating the red wavelength band of the fluorescence YL, which is non-polarized light as described above, and is therefore non-polarized light, as the fluorescence YL. The light-incident-side polarizer plate 43R therefore transmits a predetermined linearly polarized component contained in the red light LR and causes the predetermined linearly polarized component to enter the transmissive liquid crystal panel 40R.

The light-exiting-side polarizer plate 41R is provided at the light exiting side of the transmissive liquid crystal panel 40R. The light-incident-side polarizer plate 43R and the light-exiting-side polarizer plate 41R are so disposed that the polarization axes thereof are perpendicular to each other.

The light modulator 140G is disposed in the optical path of the green light LG reflected off the second dichroic mirror 133 and output from the second dichroic mirror 133.

The light modulator 140G is configured with a transmissive liquid crystal panel 40G, a light-incident-side polarizer plate 43G, and a light-exiting-side polarizer plate 41G.

The transmissive liquid crystal panel 40G modulates the incident green light LG in accordance with image information input from the image input apparatus, which is not shown, to form and output green image light.

The light-incident-side polarizer plate 43G is provided at the light incident side of the transmissive liquid crystal panel 40G. The green light LG is light that belongs to a portion obtained by separating the green wavelength band of the fluorescence YL, which is non-polarized light as described above, and is therefore non-polarized light, as the fluorescence YL. The light-incident-side polarizer plate 43G therefore transmits a predetermined linearly polarized component contained in the green light LG and causes the predetermined linearly polarized component to enter the transmissive liquid crystal panel 40G.

The light-exiting-side polarizer plate 41G is provided at the light exiting side of the transmissive liquid crystal panel 40G. The light-incident-side polarizer plate 43G and the light-exiting-side polarizer plate 41G are so disposed that the polarization axes thereof are perpendicular to each other.

The light modulator 140B is disposed in the optical path of the blue light LBs separated by the first polarizer 135.

The light modulator 140B is configured with the transmissive liquid crystal panel 40B and a light-exiting-side polarizer plate 41B. The transmissive liquid crystal panel 40B modulates the incident blue light LBs in accordance with image information input from the image input apparatus, which is not shown, to form and output blue image light.

A description will now be made about a case where the blue light LB is reflected off a mirror in place of the first polarizer 135 and enters the transmissive liquid crystal panel 40B. In this case, a light-incident-side polarizer plate is required to remove the P-polarized light contained in the blue light LB. Since the blue light LBs in the present embodiment is laser light, the light-incident-side polarizer plate is preferably a polarizer plate having a wire grid structure that excels in light resistance. When a polarizer plate having the wire grid structure transmits light polarized in a predetermined polarization direction, however, optical loss occurs due, for example, to interface reflection at the surface of the polarizer plate, resulting in a problem of a decrease in light use efficiency.

In contrast, in the present embodiment, the blue light LBs to be incident on the light modulator 140B is reflected off the first polarizer therefore separated from the blue light LB, so that the reflected blue light LBs is incident as the linearly polarized light on the transmissive liquid crystal panel 40B. Since the blue light LBs is separated from the blue light LB through reflection as described above, the separated blue light LBs can be readily guided toward the light modulator 140B. The members are therefore readily laid out.

In the projector 100 according to the present embodiment, since the first polarizer 135 functions as the light-incident-side polarizer plate for the transmissive liquid crystal panel 40B, there is no need to separately provide a polarizer plate at the light incident side of the transmissive liquid crystal panel 40G. That is, unlike the other light modulators 140R and 140G, the light modulator 140B in the present embodiment does not include a light-incident-side polarizer plate, but includes only the light-exiting-side polarizer plate 41B at the light exiting side of the transmissive liquid crystal panel 40B. The polarization axis of the light-exiting-side polarizer plate 41B is set to be perpendicular to the polarization axis of the blue light LBs incident from the first polarizer 135.

Since the first polarizer 135 is configured with a dielectric multilayer film as described above, optical loss due, for example, to interface reflection that occurs when the blue light LBs is separated from the blue light LB decreases as compared with a case where a polarizer plate having a wire grid structure is used, so that the efficiency at which the blue light LB is used can be increased.

The light combining system 150 is disposed so as to lie on the optical path of the red image light output from the light modulator 140R, the optical path of the green image light output from the light modulator 140G, and the optical path of the blue image light output from the light modulator 140B. In the plan view as shown in FIG. 1 or the side views, the position where the light combining system 150 combines the three types of color light with one another coincides with the intersection of the optical path of the red image light, the optical path of the green image light, and the optical path of the blue image light. The light combining system 150 combines the red image light, the green image light, and the blue image light with one another to form color image light. The light combining system 150 outputs the color image light. The light combining system 150 is, for example, a cross dichroic prism.

The projection system 160 is disposed in the optical path of the color image light output from the light combining system 150. The color image light output from the light combining system 150 corresponds to the light modulated by the light modulators 140R, 140G, and 140B. The projection system 160 enlarges the color image light output from the light combining system 150 and entering the projection system 160, and projects the enlarged color image light toward the screen SCR. The color image light enlarged and projected by the projection system 160 is displayed as a color video on a display surface of the screen SCR that is a surface facing a light exiting surface of the projection system 160.

The projection system 160 is configured, for example, with multiple optical lenses, and may instead be configured with a single optical lens. Examples of the optical lenses may include a variety of lenses, such as a planoconvex lens, a biconvex lens, a meniscus lens, an aspherical lens, a rod lens, and a freeform surface lens.

As described above, the projector 100 according to the present embodiment includes the light source 2, which outputs the illumination light WL containing the blue light LB, which belongs to the blue wavelength band, the first polarizer 135, which is configured with a dielectric multilayer film and separates the blue light LBs, which is the S-polarized component, out of the incident blue light LB, the transmissive liquid crystal panel 40B, which modulates the blue light LBs separated by the first polarizer 135, and the projection system 160, which projects the light modulated by the transmissive liquid crystal panel 40B.

In the projector 100 according to the present embodiment, which causes the blue light LBs, which is separated in terms of polarization from the blue light LB by the first polarizer 135 configured with a dielectric multilayer film, to enter the transmissive liquid crystal panel 40B, the efficiency at which the blue light LB is used can be increased. The transmissive liquid crystal panel 40B can therefore modulate bright image light. The projector 100 according to the present embodiment can therefore project a bright image by efficiently using the illumination light WL output from the illuminator 120.

### Second Embodiment

A projector according to a second embodiment will be subsequently described. The present embodiment differs from the first embodiment in the layout of the illuminator, the first polarizer, and other elements, and the configuration of each member due to the difference in the layout, and the other configurations are the same. The configurations relating to the difference in the layout will therefore be described below, and the members common to those in the embodiment described above have the same reference characters, and will not be described in detail.

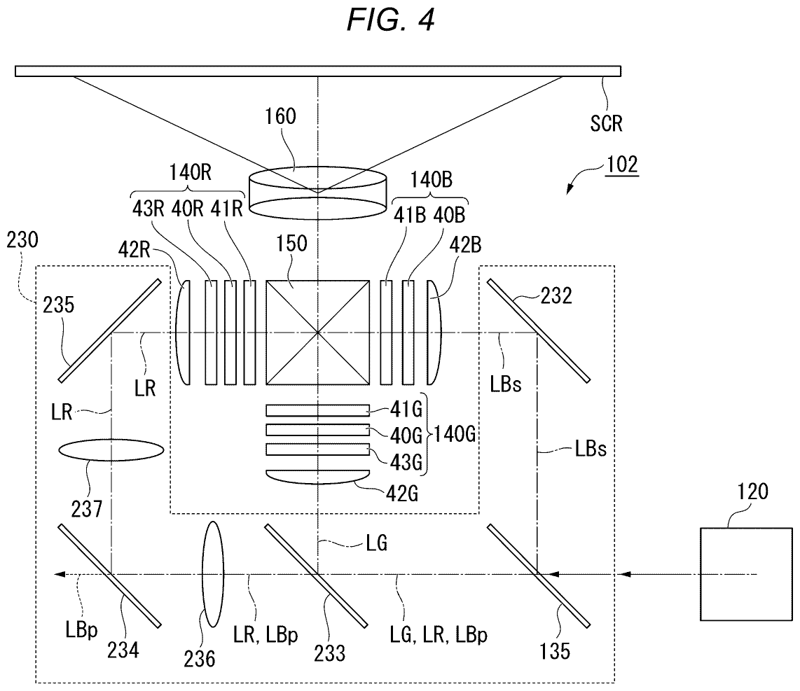

FIG. 4 shows a schematic configuration of a projector 102 according to the present embodiment.

The projector 102 according to the present embodiment includes the illuminator 120, a color separation system 230, the light modulators 140R, 140G, and 140B, the light combining system 150, and the projection system 160, as shown in FIG. 4. The positional relationship of the light modulators 140R, 140G, and 140B with respect to the light combining system 150 in the projector 102 according to the present embodiment differs from the positional relationship in the projector 100 according to the first embodiment in that the positions of the light modulators 140B and 140R are swapped. The projector 102 according to the present embodiment further differs from the projector 100 according to the first embodiment in terms of the direction in which the illumination light WL enters the color separation system 230.

The color separation system 230 in the present embodiment includes the first polarizer 135, a first mirror 232, a first dichroic mirror 233, a third dichroic mirror 234, a second mirror 235, a first relay lens 236, and a second relay lens 237.

The first polarizer 135 is disposed in the optical path of the illumination light WL output from the illuminator 120, and separates the incident illumination light WL into the red light LR, the green light LG, and the blue light LB. Specifically, the first polarizer 135 transmits the green light LG and the red light LR out of the illumination light WL. As for the blue light LB, the first polarizer 135 transmits the blue light LBp, which is the P-polarized component, and reflects the blue light LBs, which is the S-polarized component.

The first mirror 232 is disposed in the optical path of the blue light LBs reflected off the first polarizer 135, and reflects the blue light LBs toward the light modulator 140B.

The first dichroic mirror 233 is disposed in the optical path of the blue light LBp, the red light LR, and the green light LG having passed through the first polarizer 135, and separates the received light into the mixture of the blue light LBp and the red light LR, and the green light LG. The first dichroic mirror 233 transmits the blue light LBp and the red light LR and reflects the green light LG. The green light LG enters the light modulator 140G from the first dichroic mirror 233.

The third dichroic mirror 234 is disposed in the optical path of the blue light LBp and the red light LR output from the first dichroic mirror 233, and separates the blue light LBp and the red light LR from each other. The third dichroic mirror 234 transmits the blue light LBp and reflects the red light LR. Note that the amount of blue light LBp having passed through the third dichroic mirror 234 is very small and is blocked by a light blocking member that is not shown, so that the blue light LBp does not contribute to stray light.

The second mirror 235 is disposed in the optical path of the red light LR reflected off the third dichroic mirror 234, and reflects the red light LR toward the light modulator 140R.

The first relay lens 236 is disposed in the optical path of the red light LR between the first dichroic mirror 233 and the third dichroic mirror 234. The second relay lens 237 is disposed in the optical path of the red light LR between the third dichroic mirror 234 and the second mirror 235. Providing the first relay lens 236 and the second relay lens 237 compensates for optical loss of the red light LR due to the difference in the optical path length between the red light LR and the other light.

Also in the projector 102 according to the present embodiment, which causes the blue light LBs, which is separated in terms of polarization from the blue light LB by the first polarizer 135 configured with a dielectric multilayer film, to enter the transmissive liquid crystal panel 40B, the efficiency at which the blue light LB is used can be increased. The projector 102 according to the present embodiment can therefore project a bright image by efficiently using the illumination light WL.

### Third Embodiment

A projector according to a third embodiment will be subsequently described. The present embodiment differs from the first embodiment in terms of the configurations of the illuminator and the color separation system, and the other configurations are the same. The configurations of the illuminator and the color separation system will therefore be primarily described below, and the members common to those in the embodiments described above have the same reference characters, and will not be described in detail.

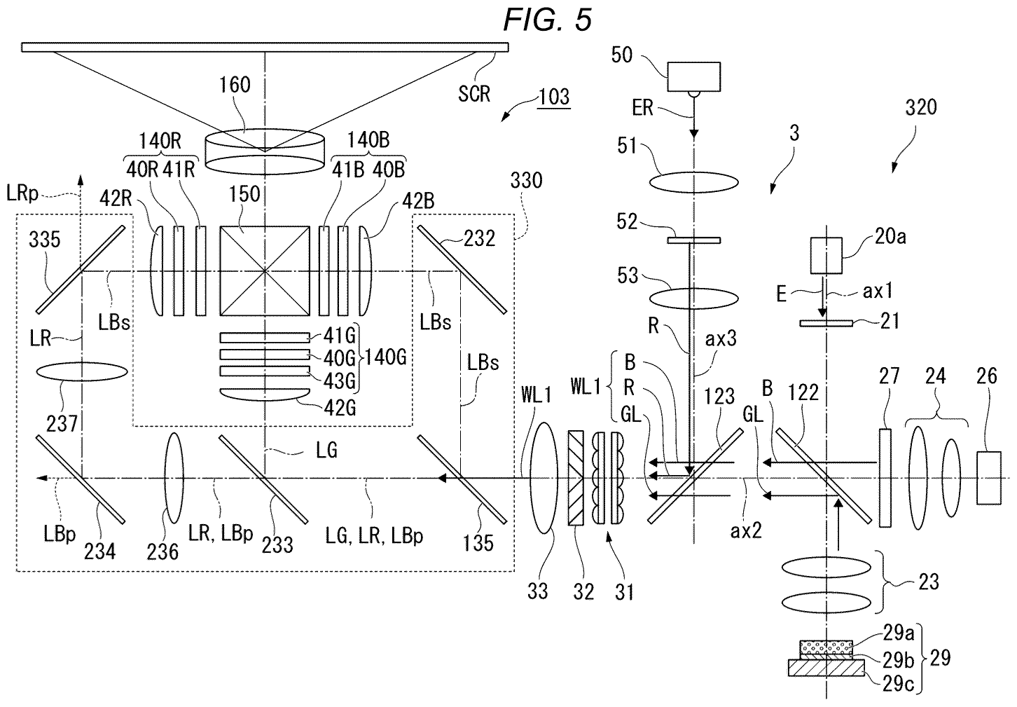

FIG. 5 shows a schematic configuration of a projector 103 according to the present embodiment.

The projector 103 according to the present embodiment includes an illuminator 320, a color separation system 330, the light modulators 140R, 140G, and 140B, the light combining system 150, and the projection system 160, as shown in FIG. 5. The positional relationship of the light modulators 140R, 140G, and 140B with respect to the light combining system 150 in the projector 103 according to the present embodiment is the same as the positional relationship in the projector 102 according to the second embodiment. Note that some of the elements of the color separation system 330 are the same as some of the elements of the color separation system 230 in the second embodiment, and the same elements have the same reference characters and will not be described.

The illuminator 320 includes a light source 3, the optical integration lens 31, the polarization converter 32, and the superimposing lens 33, as illustrated in FIG. 5.

The light source 3 includes the light emitter 20a, the first phase retarder 21, a first optical element 122, the first light collection system 23, the second light collection system 24, a wavelength converter 29, the diffuser 26, the second phase retarder 27, another light emitter 50, a first light collection lens 51, a diffuser 52, a second light collection lens 53, and a second optical element 123.

The light emitter 20a, the first phase retarder 21, the first optical element 122, the first light collection system 23, and the wavelength converter 25 are sequentially arranged in the optical axis ax1.

The diffuser 26, the second light collection system 24, the second phase retarder 27, the first optical element 122, the second optical element 123, the optical integration lens 31, the polarization converter 32, and the superimposing lens 33 are sequentially arranged in the illumination optical axis ax2. The optical axis ax1 and the illumination optical axis ax2 are present in the same plane and perpendicular to each other.

The other light emitter 50, the first light collection lens 51, the diffuser 52, the second light collection lens 53, and the second optical element 123 are sequentially arranged in the optical axis ax3. The optical axis ax3 is an optical axis of the other light emitter 50, and is parallel to the optical axis ax1, and the optical axis ax3, the optical axis ax1, and the illumination optical axis ax2 are present in the same plane.

The first optical element 122 is disposed so as to incline by the angle of 45° with respect to the optical axis ax1 and the illumination optical axis ax2. The first optical element 122 has a polarization separation function of separating the blue beam E into the beam Es, which is the S-polarized component, and the beam Ep, which is the P-polarized component, the two components polarized with respect to the first optical element 122. The first optical element 122 further has a color separation function of reflecting fluorescence GL, which belongs to a wavelength band different from that of the blue beam E, irrespective of the polarization state of the fluorescence GL.

The wavelength converter 29 includes a reflection layer 29b, a phosphor 29a, and a substrate 29c. The phosphor 29a converts the beam Ep, which is excitation light, into the fluorescence GL having a second wavelength band different from the first wavelength band. The phosphor 29a contains a ceramic phosphor configured with a polycrystalline phosphor that converts the beam Ep in terms of wavelength into the fluorescence GL. The second wavelength band to which the fluorescence GL belongs is a green wavelength band ranging, for example, from 500 nm to 570 nm. That is, the fluorescence GL is green fluorescence containing the green light component.

The green phosphor 29a described above is made, for example, of a phosphor material such as Lu₃Al₅O₁₂:Ce³⁺-based phosphor, Y₃O₄:Eu²⁺-based phosphor, (Ba, Sr)₂SiO₄:Eu²⁺-based phosphor, Ba₃Si₆O₁₂N₂:Eu²⁺-based phosphor, and (Si, Al)₆ (O, N)₈:Eu²⁺-based phosphor.

The reflection layer 29b reflects components of the fluorescence GL generated by the phosphor 29a that travel toward the substrate 29c. Out of the fluorescence GL generated by the phosphor 29a, part of the fluorescence GL is reflected off the reflection layer 29b and exits out of the phosphor 29a. Another part of the fluorescence GL generated by the phosphor 29a exits out of the phosphor 29a without traveling via the reflection layer 29b. The fluorescence GL is thus output from the wavelength converter 29. The fluorescence GL passes through the first light collection system 23 and is then incident on the first optical element 122. The fluorescence GL is reflected off the first optical element 122 and travels toward the second optical element 123.

The first optical element 122 outputs the blue light B incident from the diffuser 26 and the fluorescence GL incident from the wavelength converter 29 toward the second optical element 123.

The other light emitter 50 is configured with a semiconductor laser. The other light emitter 50 emits a red beam ER, which belongs to a red wavelength band ranging, for example, from 640 nm to 650 nm. The other light emitter 50 may be a semiconductor laser that emits a laser beam that belongs to a wavelength band other than that described above. The number of other light emitters 50 may be one or more, and is not particularly limited to a specific number.

The red beam ER emitted from the other light emitter 50 and collected by the first light collection lens 51 enters the diffuser 52, and is diffused by the diffuser 52 and parallelized by the second light collection lens 53. The second light collection lens 53 thus outputs red light R, which is parallelized light, toward the second optical element 123.

The second optical element 123 is disposed so as to incline by the angle of 45° with respect to the optical axis ax3 and the illumination optical axis ax2. The second optical element 123 is configured with a dichroic mirror having optical characteristics of reflecting the red light R and transmitting the fluorescence GL and the blue light B incident from the first optical element 122. The second optical element 123 outputs the red light R, the fluorescence GL, and the blue light B in the same direction. The red light R, the fluorescence GL, and the blue light B are therefore combined with one another by the second optical element 123 into white illumination light WL1.

The illumination light WL1 enters the color separation system 330 via the optical integration lens 31, the polarization converter 32, and the superimposing lens 33. Note that the effects of the optical integration lens 31, the polarization converter 32, and the superimposing lens 33 on the illumination light WL1 will not be described.

The color separation system 330 separates the illumination light WL1 into the red light LR, the green light LG, and the blue light LB. The red light LR corresponds to the red light R contained in the illumination light WL1, the green light LG corresponds to the green fluorescence GL contained in the illumination light WL1, and the blue light LB corresponds to the blue light B contained in the illumination light WL1. That is, the green light LG in the present embodiment corresponds to the “second light that belongs to a second wavelength band” in the claims, and the red light LR in the present embodiment corresponds to the “second laser light that belongs to a fourth wavelength band” in the claims.

The color separation system 330 includes the first polarizer 135, the first mirror 232, the first dichroic mirror 233, the third dichroic mirror 234, a second polarizer 335, the first relay lens 236, and the second relay lens 237.

The first polarizer 135 is disposed in the optical path of the illumination light WL1 output from the illuminator 320, and separates the incident illumination light WL1 into the red light LR, the green light LG, and the blue light LB. Specifically, the first polarizer 135 transmits the green light LG and the red light LR out of the illumination light WL1. As for the blue light LB, the first polarizer 135 transmits the blue light LBp, which is the P-polarized component, and reflects the blue light LBs, which is the S-polarized component.

The first polarizer 135 thus separates the green light LG and the red light LR from the blue light LBs by transmitting the green light LG and the red light LR.

The first mirror 232 is disposed in the optical path of the blue light LBs reflected off the first polarizer 135, and reflects the blue light LBs toward the light modulator 140B.

The first dichroic mirror 233 separates the blue light LBp, the red light LR, and the green light LG having passed through the first polarizer 135 into the mixture of the blue light LBp and the red light LR, and the green light LG. The first dichroic mirror 233 transmits the blue light LBp and the red light LR and reflects the green light LG. That is, the first dichroic mirror 233 separates the green light LG and the red light LR from each other by reflecting the green light LG and transmitting the blue light LBp and the red light LR. The green light LG thus enters the light modulator 140G from the first dichroic mirror 233. That is, the first dichroic mirror 233 in the present embodiment corresponds to the “light separator” in the claims.

The third dichroic mirror 234 separates the blue light LBp and the red light LR output from the first dichroic mirror 233 from each other. The third dichroic mirror 234 transmits the blue light LBp and reflects the red light LR. Note that the amount of blue light LBp having passed through the third dichroic mirror 234 is very small and is blocked by a light blocking member that is not shown, so that the blue light LBp does not contribute to stray light.

The second polarizer 335 is disposed in the optical path of the red light LR reflected off the third dichroic mirror 234. The second polarizer 335 reflects a predetermined polarized component of the red light LR and causes the reflected component to enter the light modulator 140R.

The second polarizer 335 in the present embodiment is configured with a dielectric multilayer film, and separates the S-polarized component and the P-polarized component of the incident red light LR from each other, the two components polarized with respect to the transmissive liquid crystal panel 40R of the light modulator 140R. The second polarizer 335 is disposed so as to incline by the angle of 45° with respect to the chief ray of the incident red light LR. According to the configuration described above, the exiting direction of the S-polarized component separated by the second polarizer 335 is readily controlled, so that the separated light can be efficiently incident on the light modulator 140R.

In the following description, the polarization directions of the S-polarized light and the P-polarized light in the red light LR indicate the polarization directions with respect to the transmissive liquid crystal panel 40R unless otherwise specified.

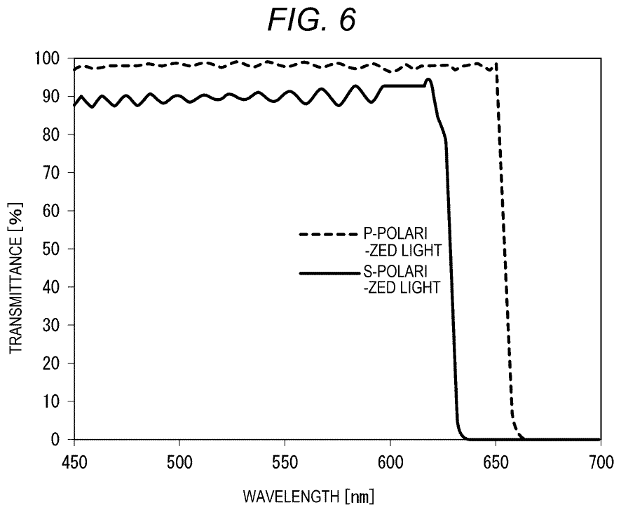

FIG. 6 depicts graphs showing the spectral characteristics of the second polarizer 335.

The second polarizer 335 is spectrally characterized to transmit the P-polarized red light LR, which belongs to the red wavelength band (fourth wavelength band) ranging from 640 nm to 650 nm and reflect the S-polarized red light LR, as shown in FIG. 6.

The red light LR, which is the laser light and is output from the illuminator 320, exits as the S-polarized light, but the red light LR passes through multiple optical components before entering the second polarizer 335, so that the polarization direction of the red light LR is slightly disturbed. Therefore, the red light LR is light primarily made of the S-polarized light, but slightly contains the P-polarized light.

The second polarizer 335 transmits red light LRp, which is the P-polarized component, out of the incident red light LR, and reflects red light LRs, which is the S-polarized component, out of the red light LR. Note that the amount of red light LRp passing through the second polarizer 335 is very small and is blocked by a light blocking member that is not shown, so that the red light LRp does not contribute to stray light.

The first relay lens 236 is disposed in the optical path of the red light LR between the first dichroic mirror 233 and the third dichroic mirror 234. The second relay lens 237 is disposed in the optical path of the red light LR between the third dichroic mirror 234 and the second polarizer 335. Providing the first relay lens 236 and the second relay lens 237 compensates for optical loss of the red light LR due to the difference in the optical path length between the red light LR and the other light.

The second polarizer 335 thus separates the red light LRs, which is the S-polarized component, which is the first polarized component, out of the red light LR, and causes the red light LRs to enter the transmissive liquid crystal panel 40R of the light modulator 140R. The transmissive liquid crystal panel 40R in the present embodiment corresponds to the “second transmissive liquid crystal panel” in the claims.

The light modulator 140R in the present embodiment is configured with the transmissive liquid crystal panel 40R and the light-exiting-side polarizer plate 41R. Since the second polarizer 335 functions as the light-incident-side polarizer plate for the transmissive liquid crystal panel 40R, there is no need to separately provide a polarizer plate at the light incident side of the transmissive liquid crystal panel 40R. That is, the light modulator 140R in the present embodiment does not include a light-incident-side polarizer plate, but includes only the light-exiting-side polarizer plate 41R at the light exiting side of the transmissive liquid crystal panel 40R, as the light modulator 140B. The polarization axis of the light-exiting-side polarizer plate 41R is set to be perpendicular to the polarization axis of the red light LRs incident from the second polarizer 335.

Since the second polarizer 335 is configured with a dielectric multilayer film as described above, optical loss due, for example, to interface reflection that occurs when the red light LRs is separated from the red light LR decreases as compared with a case where a polarizer plate having a wire grid structure is used, so that the efficiency at which the red light LR is used can be increased.

The projector 103 according to the present embodiment can cause the red light LRs, which is separated in terms of polarization from the red light LR by the second polarizer 335 configured with a dielectric multilayer film, to be incident on the transmissive liquid crystal panel 40R, in addition to the effects provided by the first polarizer 135. The efficiency at which the blue light LB and the red light LR are used can therefore be increased. The projector 103 according to the present embodiment can therefore project a brighter image by efficiently using the illumination light WL1 output from the illuminator 320.

### Fourth Embodiment

A projector according to a fourth embodiment will be subsequently described. The present embodiment differs from the first embodiment in terms of the configurations of the illuminator and the color separation system, and the other configurations are the same. The configurations of the illuminator and the color separation system will therefore be primarily described below, and the members common to those in the embodiments described above have the same reference characters, and will not be described in detail.

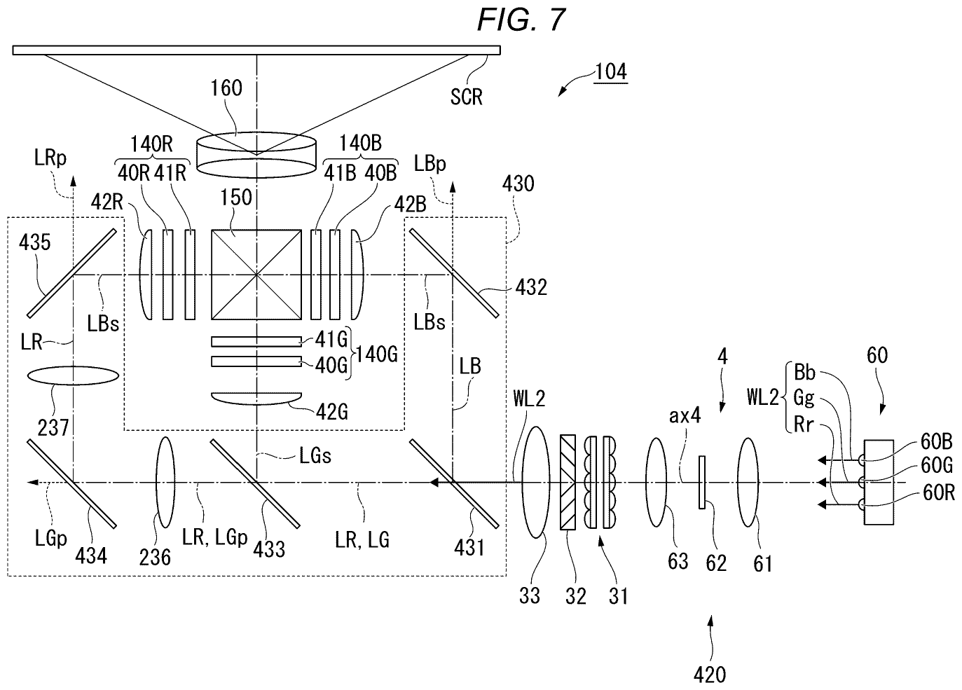

FIG. 7 shows a schematic configuration of a projector 104 according to the present embodiment.

The projector 104 according to the present embodiment includes an illuminator 420, a color separation system 430, the light modulators 140R, 140G, and 140B, the light combining system 150, and the projection system 160, as shown in FIG. 7. The positional relationship of the light modulators 140R, 140G, and 140B with respect to the light combining system 150 in the projector 104 according to the present embodiment is the same as the positional relationship in the projector 102 according to the second embodiment. Note that some of the elements of the color separation system 430 are the same as some of the elements of the color separation system 230 in the second embodiment, and the same elements have the same reference characters and will not be described.

The illuminator 420 includes a light source 4, the optical integration lens 31, the polarization converter 32, and the superimposing lens 33, as shown in FIG. 7. The illuminator 420 in the present embodiment differs from those in the embodiments described above in that the illuminator 420 outputs illumination light that is laser light.

The light source 4 in the present embodiment includes a light emitter section 60, a first light collection lens 61, a diffuser 62, and a second light collection lens 63. The light emitter section 60, the first light collection lens 61, the diffuser 62, and the second light collection lens 63 are sequentially arranged in an optical axis ax4 of the light emitter section 60.

The light emitter section 60 includes a red light emitting section 60R, a green light emitting section 60G, and a blue light emitting section 60B. The red light emitting section 60R is configured with a semiconductor laser that outputs red laser light Rr, which belongs, for example, to the red wavelength band ranging from 640 nm to 650 nm. The green light emitting section 60G is configured with a semiconductor laser that outputs green laser light Gg, which belongs to a green wavelength band ranging, for example, from 520 nm to 545 nm. The blue light emitting section 60B is configured with a semiconductor laser that outputs blue laser light Bb, which belongs, for example, to the blue wavelength band ranging from 445 nm to 460 nm. The light emitter section 60 in the present embodiment has a unit structure in which the red light emitting section 60R, the green light emitting section 60G, and the blue light emitting section 60B are mounted on the same substrate.

Based on the configuration described above, the light emitter section 60 emits white illumination light WL2 containing the red laser light Rr, the green laser light Gg, and the blue laser light Bb.

The white illumination light WL2 emitted from the light emitter section 60 is collected by the first light collection lens 61, enters the diffuser 62, and is diffused by the diffuser 62 and parallelized by the second light collection lens 63. The second light collection lens 63 thus outputs the illumination light WL2 that is parallelized light toward the optical integration lens 31.

The illumination light WL2 enters the color separation system 430 via the optical integration lens 31, the polarization converter 32, and the superimposing lens 33. Note that the effects of the optical integration lens 31, the polarization converter 32, and the superimposing lens 33 on the illumination light WL2 will not be described.

The color separation system 430 separates the illumination light WL2 into the red light LR, the green light LG, and the blue light LB. The red light LR corresponds to the red laser light Rr contained in the illumination light WL2, the green light LG corresponds to the green laser light Gg contained in the illumination light WL2, and the blue light LB corresponds to the blue laser light Bb contained in the illumination light WL2. That is, the blue light LB in the present embodiment corresponds to the “first laser light that belongs to a first wavelength band” in the claims, the green light LG in the present embodiment corresponds to the “second laser light that belongs to a third wavelength band” in the claims, and the red light LR in the present embodiment corresponds to the “third laser light that belongs to a fourth wavelength band” in the claims.

The color separation system 430 includes a first dichroic mirror 431, a first polarizer 432, a second polarizer 433, a second dichroic mirror 434, a third polarizer 435, the first relay lens 236, and the second relay lens 237.

The first dichroic mirror 431 is disposed in the optical path of the illumination light WL2 output from the illuminator 420, and separates the incident illumination light WL2 into the red light LR, the green light LG, and the blue light LB. Specifically, the first dichroic mirror 431 reflects the blue light LB out of the illumination light WL2 and transmits the green light LG and the red light LR out of the illumination light WL2. That is, the first dichroic mirror 431 in the present embodiment corresponds to the “light separator” in the claims.

The first polarizer 432 is disposed in the optical path of the blue light LB reflected off the first dichroic mirror 431. The first polarizer 432 in the present embodiment is configured with a dielectric multilayer film, and separates the S-polarized component and the P-polarized component of the incident blue light LB from each other, the two components polarized with respect to the transmissive liquid crystal panel 40B of the light modulator 140B. The first polarizer 432 in the present embodiment has spectral characteristics that are the same as those of the first polarizer 135 of the projector 100 according to the first embodiment. That is, the first polarizer 432 transmits the blue light LBp, which is the P-polarized component, out of the blue light LB, and reflects the blue light LBs, which is the S-polarized component, out of the blue light LB.

The first polarizer 432 is disposed so as to incline by the angle of 45° with respect to the chief ray of the incident blue light LB. According to the configuration described above, the exiting direction of the S-polarized component separated by the first polarizer 432 is readily controlled, so that the separated blue light LBs can be efficiently incident on the light modulator 140B.

The second polarizer 433 is disposed in the optical path of the red light LR and the green light LG having passed through the first dichroic mirror 431. The second polarizer 433 transmits the red light LR and reflects the green light LG. The second polarizer 433 reflects a predetermined polarized component of the green light LG and causes the reflected component to enter the light modulator 140G.

The second polarizer 433 in the present embodiment is configured with a dielectric multilayer film, and separates the S-polarized component and the P-polarized component of the incident green light LG from each other, the two components polarized with respect to the transmissive liquid crystal panel 40G of the light modulator 140G. The second polarizer 433 is disposed so as to incline by the angle of 45° with respect to the chief ray of the incident green light LG. According to the configuration described above, the light exiting direction of the S-polarized component separated by the second polarizer 433 is readily controlled, so that the separated light can be efficiently incident on the light modulator 140G.

In the following description, the polarization directions of S-polarized light and P-polarized light in the green light LG indicate the polarization directions with respect to the transmissive liquid crystal panel 40G unless otherwise specified.

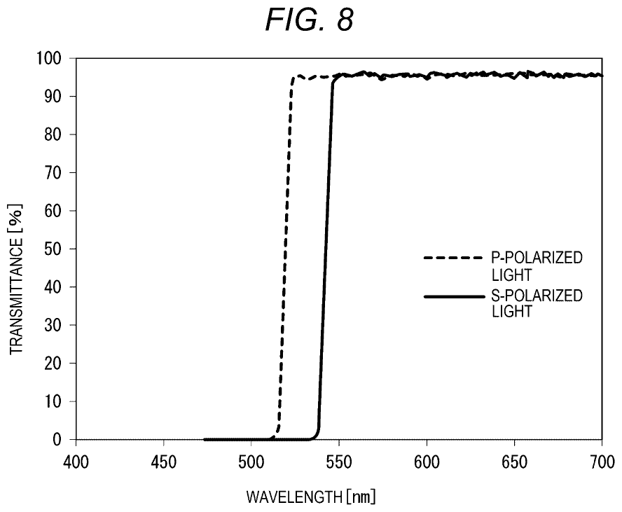

FIG. 8 depicts graphs showing the spectral characteristics of the second polarizer 433.

The second polarizer is spectrally 433 characterized to transmit the P-polarized green light LG, which belongs to the green wavelength band (third wavelength band) ranging from 520 nm to 545 nm and reflect the S-polarized green light LG, as shown in FIG. 8.

The green light LG, which is the laser light and is output from the illuminator 420, exits as the S-polarized light, but the green light LG passes through multiple optical components before entering the second polarizer 433, so that the polarization direction of the green light LG is slightly disturbed. Therefore, the green light LG is light primarily made of the S-polarized light, but slightly contains the P-polarized light.

The second polarizer 433 transmits green light LGp, which is the P-polarized component, out of the incident green light LG, and reflects green light LGs, which is the S-polarized component, out of the green light LG. Note that the amount of green light LGp passing through the second polarizer 433 is very small and is blocked by a light blocking member that is not shown, so that the green light LGp does not contribute to stray light.

The second polarizer 433 thus separates the green light LGs, which is the S-polarized component, which is the first polarized component, out of the green light LG, and causes the green light LGs to enter the transmissive liquid crystal panel 40G of the light modulator 140G. The transmissive liquid crystal panel 40G in the present embodiment corresponds to the “second transmissive liquid crystal panel” in the claims.

The second dichroic mirror 434 separates the green light LGp and the red light LR output from the second polarizer 433 from each other. The second dichroic mirror 434 transmits the blue light LBp and reflects the red light LR. Note that the amount of blue light LBp having passed through the second dichroic mirror 434 is very small and is blocked by a light blocking member that is not shown, so that the blue light LBp does not contribute to stray light.

The third polarizer 435 is disposed in the optical path of the red light LR reflected off the second dichroic mirror 434. The third polarizer 435 reflects a predetermined polarized component of the red light LR and causes the reflected component to enter the light modulator 140R.

The third polarizer 435 in the present embodiment has spectral characteristics that are the same as those of the second polarizer 335 in the third embodiment shown in FIG. 6. The third polarizer 435 therefore separates the red light LRs, which is the S-polarized component, which is the first polarized component, out of the red light LR, and causes the red light LRs to enter the transmissive liquid crystal panel 40R of the light modulator 140R. The transmissive liquid crystal panel 40R in the present embodiment corresponds to the “third transmissive liquid crystal panel” in the claims.

The first relay lens 236 is disposed in the optical path of the red light LR between the second polarizer 433 and the second dichroic mirror 434. The second relay lens 237 is disposed in the optical path of the red light LR between the second dichroic mirror 434 and the third polarizer 435. Providing the first relay lens 236 and the second relay lens 237 compensates for optical loss of the red light LR due to the difference in the optical path length between the red light LR and the other light.

In the projector 104 according to the present embodiment, the light modulators 140R, 140G, and 140B each donot include a light-incident-side polarizer plate, but include only the light-exiting-side polarizer plates 41R, 41G, and 41B at the light exiting side of the transmissive liquid crystal panels 40R, 40G, and 40B.

The projector 104 according to the present embodiment allows the red light LRs, the green light LGs, and the blue light LBs, which are separated in terms of polarization by the polarizers each configured with a dielectric multilayer film from the red light LR, the green light LG, and the blue light LB, respectively, which are each laser light, to enter the liquid crystal panels 40R, 40G, and 40B, respectively. The projector 104 according to the present embodiment can therefore project a bright color image by efficiently using the illumination light WL2 output from the illuminator 420.

### Fifth Embodiment

A projector according to a fifth embodiment will be subsequently described. The present embodiment differs from the first embodiment in terms of the configurations of the illuminator and the color separation system, and the other configurations are the same. The illuminator in the present embodiment is the same as the illuminator 320 in the third embodiment. The configurations of the illuminator and the color separation system will be primarily described below, and the members common to those in the embodiments described above have the same reference characters, and will not be described in detail.

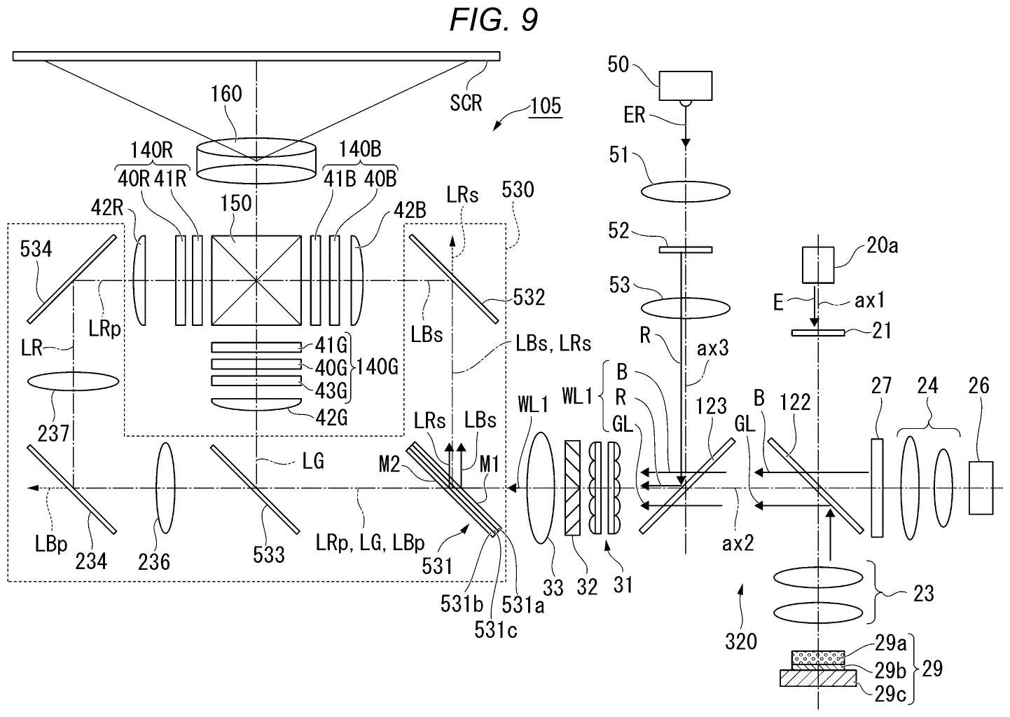

FIG. 9 shows a schematic configuration of a projector 105 according to the present embodiment.

The projector 105 according to the present embodiment includes the illuminator 320, a color separation system 530, the light modulators 140R, 140G, and 140B, the light combining system 150, and the projection system 160, as shown in FIG. 9. The positional relationship of the light modulators 140R, 140G, and 140B with respect to the light combining system 150 in the projector 105 according to the present embodiment is the same as the positional relationship in the projector 103 according to the third embodiment. Note that some of the elements of the color separation system 530 are the same as some of the elements of the color separation system 330 in the third embodiment, and the same elements have the same reference characters and will not be described.

The illuminator 320 outputs the illumination light WL1 toward the color separation system 530, as shown in FIG. 9. The color separation system 530 separates the illumination light WL1 into the red light LR, the green light LG, and the blue light LB. The red light LR corresponds to the red light R contained in the illumination light WL1, the green light LG corresponds to the green fluorescence GL contained in the illumination light WL1, and the blue light LB corresponds to the blue light B contained in the illumination light WL1. That is, the green light LG in the present embodiment corresponds to the “second light that belongs to a second wavelength band” in the claims, and the red light LR in the present embodiment corresponds to the “second laser light that belongs to a fourth wavelength band” in the claims.

The color separation system 530 includes a first polarizer 531, a first dichroic mirror 532, a second dichroic mirror 533, the third dichroic mirror 234, a mirror 534, the first relay lens 236, and the second relay lens 237.

The first polarizer 531 is disposed in the optical path of the illumination light WL1 output from the illuminator 320, and separates the incident illumination light WL1 into the red light LR, the green light LG, and the blue light LB. Specifically, the first polarizer 531 transmits the green light LG out of the illumination light WL1. As for the blue light LB, the first polarizer 531 transmits the blue light LBp, which is the P-polarized component, and reflects the blue light LBs, which is the S-polarized component. The first polarizer 531 transmits the red light LRp, which is the P-polarized component, out of the red light LR, and reflects the red light LRs, which is the S-polarized component, out of the red light LR.

The first polarizer 531 has a first surface M1, on which the illumination light WL1 is incident, and a second surface M2 opposite from the first surface M1. The first polarizer 531 includes a first film 531a disposed at the first surface M1, a second film 531b disposed at the second surface M2, and a transparent base 531c, which supports the first film 531a and the second film 531b. That is, the surface of the first film 531a that is opposite from the transparent base 531c corresponds to the first surface M1, and the surface of the second film 531b that is opposite from the transparent base 531c corresponds to the second surface M2.

The first film 531a is configured with a dielectric multilayer film, and has optical characteristics of transmitting the red light LR out of the illumination light WL1 and reflecting the blue light LBs, which is the first polarized component, out of the blue light LB. The first film 531a further has optical characteristics of transmitting the blue light LBp, which is the second polarized component, out of the blue light LB. The blue light LBs reflected off the first film 531a exits toward the first dichroic mirror 532. The red light LR and the blue light LBp pass through the transparent base 531c and are incident on the second film 531b.

The second film 531b is configured with a dielectric multilayer film, and has optical characteristics of reflecting the red light LRs, which is the first polarized component, out of red light LR, and transmitting the blue light LBp out of the blue light LB. The red light LRs reflected off the second film 531b passes through the transparent base 531c and the first film 531a and exits toward the first dichroic mirror 532.

The first dichroic mirror 532 is disposed in the optical path of the blue light LBs and the red light LRs reflected off the first polarizer 531. The first dichroic mirror 532 reflects the blue light LBs and transmits the red light LRs to separate the blue light LBs and the red light LRs from each other. The blue light LBs thus enters the light modulator 140B from the first dichroic mirror 532. That is, the first dichroic mirror 532 in the present embodiment corresponds to the “light separator” in the claims.

The second dichroic mirror 533 separates the blue light LBp, the red light LRp, and the green light LG having passed through the first polarizer 531 into the mixture of the blue light LBp and the red light LRp, and the green light LG. The second dichroic mirror 533 transmits the blue light LBp and the red light LRp and reflects the green light LG. That is, the second dichroic mirror 533 separates the green light LG from the mixture of the red light LRp and the blue light LBp by reflecting the green light LG and transmitting the blue light LBp and the red light LRp. The green light LG thus enters the light modulator 140G from the first dichroic mirror 233.

The third dichroic mirror 234 is disposed in the optical path of the blue light LBp and the red light LR output from the second dichroic mirror 533, and separates the blue light LBp and the red light LR from each other. The third dichroic mirror 234 transmits the blue light LBp and reflects the red light LR. Note that the amount of blue light LBp having passed through the third dichroic mirror 234 is very small and is blocked by a light blocking member that is not shown, so that the blue light LBp does not contribute to stray light.

The mirror 534 is disposed in the optical path of the red light LRs output from the third dichroic mirror 234, and reflects the red light LRs toward the light modulator 140R. The red light LRs, which is the S-polarized component, which is the first polarized component, out of the red light LR, thus enters the transmissive liquid crystal panel 40R of the light modulator 140R. The transmissive liquid crystal panel 40R in the present embodiment corresponds to the “second transmissive liquid crystal panel” in the claims.

The first relay lens 236 is disposed in the optical path of the red light LR between the second dichroic mirror 533 and the third dichroic mirror 234. The second relay lens 237 is disposed in the optical path of the red light LR between the third dichroic mirror 234 and the mirror 534. Providing the first relay lens 236 and the second relay lens 237 compensates for optical loss of the red light LR due to the difference in the optical path length between the red light LR and the other light.

The projector 105 according to the present embodiment, in which the first polarizer 531 aligns the polarization directions of the blue light LB and the red light LR with each other, allows an increase in the light use efficiency with the number of polarizers used in the color separation system 530 reduced, so that a bright image can be projected.

Note that the technical scope of the present disclosure is not limited to the embodiments described above, and a variety of changes can be made thereto without departing from the intent of the present disclosure.

The specific descriptions of the shapes, the numbers, the arrangements, the materials, and other factors of the elements of the projector shown in the embodiments described above are not limited to those in the embodiments described above and can be changed as appropriate.

For example, the projector 100 according to the first embodiment has been described with reference to the case where the blue light LB contained in the illumination light WL is generated by using laser light and the green light LG and the red light LR are generated by using fluorescence, and the present disclosure is also applicable to a case where one of the green light LG and the red light LR is generated by using laser light and the other two kinds of color light are generated by using fluorescence.

The projector 103 according to the third embodiment has been described with reference to the case where the green light LG contained in the illumination light WL1 is generated by using fluorescence and the red light LR is generated by using laser light, and the present disclosure is also applicable to a case where the green light LG is generated by using laser light and the red light LR is generated by using fluorescence.

The present disclosure will be summarized below as additional remarks.

### Additional Remark 1

A projector including:
a light source configured to output light containing first laser light that belongs to a first wavelength band;
a first polarizer configured with a dielectric multilayer film and configured to separate a first polarized component of the first laser light incident on the first polarizer;
a first transmissive liquid crystal panel configured to modulate the first polarized component of the first laser light separated by the first polarizer; and
a projection system configured to project the light modulated by the first transmissive liquid crystal panel,
wherein the first polarizer separates the first polarized component of the first laser light to cause the first polarized component to enter the first transmissive liquid crystal panel.

According to the thus configured projector, which causes the first polarized component, which is separated in terms of polarization from the first laser light by the first polarizer configured with a dielectric multilayer film, to enter the first transmissive liquid crystal panel, the efficiency at which the first laser light is used can be increased. The first transmissive liquid crystal panel can therefore modulate bright image light. The thus configured projector can therefore project a bright image by efficiently using the first laser light output from the light source.

### Additional Remark 2

The projector according to the additional remark 1, further comprising
a polarization converter configured to convert the light output from the light source into the first polarized component.

The configuration described above, in which the polarization converter aligns illumination light output from the light source with the first polarized component in terms of polarization direction, can reduce optical loss caused when the illumination light is separated in terms of polarization to further increase the light use efficiency.

### Additional Remark 3

The projector according to the additional remark 1 or 2, wherein
the light output from the light source further contains second light that is fluorescence that belongs to a second wavelength band different from the first wavelength band, and
the first polarizer transmits the second light incident thereon to separate the first polarized component of the first laser light from the second light.

According to the configuration described above, even when the illumination light output from the light source contains the second light, which is fluorescence, the first polarized component of the first laser light can be separated from the illumination light.

### Additional Remark 4

The projector according to the additional remark 1 or 2, wherein
the light output from the light source further contains laser light that belongs to a third wavelength band different from the first wavelength band, and
the projector further includes:
a light separator configured to separate the first laser light and the second laser light from each other by reflecting the first laser light and transmitting the second laser light;
a second polarizer configured with a dielectric multilayer film and configured to reflect the first polarized component of the second laser light incident from the light separator to separate the first polarized component from the second laser light, and
a second transmissive liquid crystal panel configured to modulate the first polarized component of the second laser light separated by the second polarizer.

The configuration described above, which includes the second polarizer configured with a dielectric multilayer film, allows the first polarized component separated in terms of polarization from the second laser light to enter the second transmissive liquid crystal panel. When the illumination light output from the light source contains the first laser light and the second laser light that belong to wavelength bands different from each other, the illumination light can therefore be efficiently used to project a bright color image.

### Additional Remark 5

The projector according to the additional remark 4, wherein
the light output from the light source further contains third laser light that belongs to a fourth wavelength band different from the wavelength bands to which the first laser light and the second laser light belong, and
the second polarizer is configured to separate an optical path of the first polarized component of the second laser light and an optical path of the third laser light from each other by transmitting the third laser light.

According to the configuration described above, even when the illumination light output from the light source contains the third laser light, the first polarized component of the second laser light can be separated from the illumination light.

### Additional Remark 6

The projector according to the additional remark 5, further including:
a third polarizer configured with a dielectric multilayer film and configured to reflect the first polarized component of the third laser light passing through the second polarizer and incident on the third polarizer to separate the first polarized component from the third laser light; and
a third transmissive liquid crystal panel configured to modulate the first polarized component of the third laser light separated by the third polarizer.

The configuration described above, which includes the third polarizer configured with a dielectric multilayer film, allows the first polarized component separated in terms of polarization from the third laser light to enter the third transmissive liquid crystal panel. The projector can therefore efficiently use the illumination light containing the three types of laser light having different colors to project a bright color image.

### Additional Remark 7

The projector according to the additional remark 6, wherein
the first laser light is blue laser light,
the second laser light is green laser light, and
the third laser light is red laser light.

According to the configuration described above, a projector that projects a bright full-color image by efficiently using the illumination light containing the red laser light, the green laser light, and the blue laser light.

### Additional Remark 8

The projector according to the additional remark 3, wherein
the light output from the light source further contains second laser light that belongs to a fourth wavelength band different from the first wavelength band, and
the projector further includes:
a light separator configured to separate the second light and the second laser light from each other by reflecting the second light and transmitting the second laser light;
a second polarizer configured with a dielectric multilayer film and configured to reflect the first polarized component of the second laser light incident from the light separator to separate the first polarized component from the second laser light, and
a second transmissive liquid crystal panel configured to modulate the first polarized component of the second laser light separated by the second polarizer.

When the illumination light output from the light source contains the second light, which is fluorescence, and the second laser light, the configuration described above allows the first polarized component of the second laser light separated from the illumination light to enter the second transmissive liquid crystal panel. The projector can therefore project a bright color image by efficiently using the illumination light containing the two types of laser light having different colors.

### Additional Remark 9

The projector according to the additional remark 1 or 2, wherein
the light output from the light source further contains second laser light that belongs to a fourth wavelength band different from the first wavelength band, and
the first polarizer includes
a first film that is disposed at a first surface of the first polarizer on which the light output from the light source is incident and configured to reflect the first polarized component 4 the first laser light while transmitting the second laser light, and
a second film that is disposed at a second surface of the first polarizer opposite from the first surface and configured to transmit a second polarized component of the first laser light that is polarized in a polarization direction different from the polarization direction of the first polarized component and the second polarized component of the second laser light while reflecting the first polarized component of the second laser light, and
the projector further includes:
a light separator configured to separate the first polarized component of the first laser light and the first polarized component of the second laser light from each other by reflecting the first polarized component of the first laser light incident from the first polarizer and transmitting the first polarized component of the second laser light incident from the first polarizer, and
a second transmissive liquid crystal panel configured to modulate the second polarized component of the second laser light that passes through the second film of the first polarizer.

A projector having the configuration described above, in which the first polarizer aligns the polarization directions of the first laser light and the second laser light with each other, can project a bright image by using the light at increased efficiency with the number of polarizers used in the color separation system reduced.

### Additional Remark 10

The projector according to any one of the additional remarks 1 to 9, wherein
the first polarizer separates the first polarized component from the first laser light by reflecting the first polarized component.

The configuration described above, which separates the first polarized component from the first laser light by reflecting the first polarized component, can readily guide the separated first polarized component toward the first transmissive liquid crystal panel. The members are therefore readily laid out.

### Additional Remark 11

The projector according to the additional remark 10, wherein
the first polarizer is disposed so as to incline by an angle of 45 degrees with respect to a chief ray of the first laser light incident on the first polarizer.

According to the configuration described above, the exiting direction of the first polarized component separated by the first polarizer is readily controlled, so that the separated light can be efficiently incident on the first transmissive liquid crystal panel.

What is claimed is:

1. A projector comprising:
a light source configured to output light containing first laser light that belongs to a first wavelength band;
a first polarizer configured with a dielectric multilayer film and configured to separate a first polarized component of the first laser light incident on the first polarizer;
a first transmissive liquid crystal panel configured to modulate the first polarized component of the first laser light separated by the first polarizer; and
a projection system configured to project the light modulated by the first transmissive liquid crystal panel,
wherein the first polarizer separates the first polarized component of the first laser light to cause the first polarized component to enter the first transmissive liquid crystal panel.

2. The projector according to claim 1, further comprising
a polarization converter configured to convert the light output from the light source into the first polarized component.

3. The projector according to claim 1, wherein
the light output from the light source further contains second light that is fluorescence that belongs to a second wavelength band different from the first wavelength band, and
the first polarizer transmits the second light incident thereon to separate the first polarized component of the first laser light from the second light.

4. The projector according to claim 1, wherein
the light output from the light source further contains second laser light that belongs to a third wavelength band different from the first wavelength band, and
the projector further comprises:
a light separator configured to separate the first laser light and the second laser light from each other by reflecting the first laser light and transmitting the second laser light;
a second polarizer configured with a dielectric multilayer film and configured to reflect the first polarized component of the second laser light incident from the light separator to separate the first polarized component from the second laser light, and
a second transmissive liquid crystal panel configured to modulate the first polarized component of the second laser light separated by the second polarizer.

5. The projector according to claim 4, wherein
the light output from the light source further contains third laser light that belongs to a fourth wavelength band different from the wavelength bands to which the first laser light and the second laser light belong, and
the second polarizer is configured to separate an optical path of the first polarized component of the second laser light and an optical path of the third laser light from each other by transmitting the third laser light.

6. The projector according to claim 5, further comprising:
a third polarizer configured with a dielectric multilayer film and configured to reflect the first polarized component of the third laser light passing through the second polarizer and incident on the third polarizer to separate the first polarized component from the third laser light; and
a third transmissive liquid crystal panel configured to modulate the first polarized component of the third laser light separated by the third polarizer.

7. The projector according to claim 6, wherein
the first laser light is blue laser light,
the second laser light is green laser light, and
the third laser light is red laser light.

8. The projector according to claim 3, wherein
the light output from the light source further contains second laser light that belongs to a fourth wavelength band different from the first wavelength band, and
the projector further comprises:
a light separator configured to separate the second light and the second laser light from each other by reflecting the second light and transmitting the second laser light;
a second polarizer configured with a dielectric multilayer film and configured to reflect the first polarized component of the second laser light incident from the light separator to separate the first polarized component from the second laser light, and
a second transmissive liquid crystal panel configured to modulate the first polarized component of the second laser light separated by the second polarizer.

9. The projector according to claim 1, wherein
the light output from the light source further contains second laser light that belongs to a fourth wavelength band different from the first wavelength band, and
the first polarizer includes
a first film that is disposed at a first surface of the first polarizer on which the light output from the light source is incident and configured to reflect the first polarized component of the first laser light while transmitting the second laser light, and
a second film that is disposed at a second surface of the first polarizer opposite from the first surface and configured to transmit a second polarized component of the first laser light that is polarized in a polarization direction different from the polarization direction of the first polarized component and the second polarized component of the second laser light while reflecting the first polarized component of the second laser light, and
the projector further comprises:
a light separator configured to separate the first polarized component of the first laser light and the first polarized component of the second laser light from each other by reflecting the first polarized component of the first laser light incident from the first polarizer and transmitting the first polarized component of the second laser light incident from the first polarizer, and
a second transmissive liquid crystal panel configured to modulate the second polarized component of the second laser light that passes through the second film of the first polarizer.

10. The projector according to claim 1, wherein
the first polarizer separates the first polarized component from the first laser light by reflecting the first polarized component.

11. The projector according to claim 10, wherein
the first polarizer is disposed so as to incline by an angle of 45 degrees with respect to a chief ray of the first laser light incident on the first polarizer.
